(19) United States
(12) Patent Application Publication
(10) Pub. No.: US 2026/0338810 A1
(43) Pub. Date: Oct. 29, 2026

(54) DEVICE ADAPTED TO RETRIEVE HISTOLOGICAL SLIDES AND/OR BIOCASSETTES

(71) Applicant: LOGIBIOTECH S.R.L., MILANO (IT)

(72) Inventor: Lorenzo CAMPANINI, FIDENZA (PR) (IT)

(21) Appl. No.: 19/101,684

(22) PCT Filed: Jul. 19, 2023
(86) PCT No.: PCT/IT2023/050168

§ 371 Date: Feb. 6, 2025

(30) Foreign Application Priority Data
Aug. 9, 2022 (IT) 102022000017028

(51) Int. Cl. G01N 35/00

(52) U.S. Cl. CPC G01N 35/00732; G01N 2035/00801; G01N 2035/0091

(57) ABSTRACT

The invention concerns a device (1) adapted to retrieve histological slides and/or biocassettes previously positioned in an orderly fashion in rows and/or columns in a filing box (CL) by means of a centralized electronic filing system, comprising:—a load-bearing structure (SC, SL1, SL2) and a base (2) for resting on work surfaces for said load-bearing structure comprising reversible blocking means (3) of a filing box (CL) of slides and/or biocassettes, where said filing box and said slides and/or biocassettes comprise automatically readable identification codes;—a saddle (4), associated with said load-bearing structure by means of two-way translation means, and a head (5) associated with said saddle (4) by means of two-way rotation means;—a first code reader (6) adapted to automatically acquire said identification code of the filing box (CL);—a laser pointer (7) adapted to emit a light beam;—an interface device (8), comprising hardware and/or software means for translation of the saddle (4) and rotation of the head (5). Said interface device (8) is

### TECHNICAL FIELD

The invention is aimed at the technical field of medical devices that can be used in procedures for filing bioptic samples.

More in detail, the invention concerns a device adapted to retrieve histological slides and/or biocassettes contained in filing boxes.

### BACKGROUND ART

In the hospital environment there is the need to provide for filing and storage of bioptic samples in order to allow the performance of subsequent clinical evaluations thereon, after retrieval of these samples.

In current hospital filing and storage procedures of bioptic samples, slides and/or biocassettes containing the samples are first inserted into specific modular filing boxes, where they are arranged in an orderly fashion in rows or rows and columns, and these filing boxes are subsequently inserted into specific cabinets for short, medium or long term storage.

Operations for insertion of the slides and/or the biocassettes into the filing boxes and for insertion of the filing boxes into storage cabinets are managed by automatic or semi-automatic systems, through electronic programmes that memorize the filing position of each single sample, hence capable of ensuring correct ordering of the samples processed and of facilitating their retrieval, in case of need.

### PRESENTATION OF THE INVENTION

A prior application for a patent for industrial invention, N° 102019000012333 dated Jul. 19, 2019, filed in the name of the owner of the present application, describes a procedure for filing and tracking cyto-histological slides and histological biocassettes, capable of assisting operators during the filing or retrieval of slides and/or biocassettes, supplying them with interactive communications regarding the positions occupied by said slides and/or by said biocassettes inside corresponding filing boxes and storage cabinets.

This procedure has the defect of requiring the operator to identify the position occupied in the filing box by the slides and/or by the biocassettes concerned by the retrieval procedures, with consequent long performance times and also high probabilities of errors in detecting the position and retrieving said slides and/or biocassettes from the filing box.

Therefore, the object of the invention is to overcome the aforesaid negative aspects.

The object of the invention is achieved with a device for retrieving histological slides and/or biocassettes according to the main independent claim 1.

Further features of the invention are described in the dependent claims.

A device for retrieving histological slides and/or biocassettes according to the invention produces the following important advantages:
by means of a laser pointer, which can be selectively oriented and activated, it allows the exact slides and exact biocassettes to be retrieved to be visually indicated to operators;
by means of the light beam emitted by said laser pointer, it allows the operations to retrieve said slides and said biocassettes to be expedited;
by means of said laser pointer, it allows human errors of recognition of the filing position occupied by said slides and said biocassettes in the filing boxes to be limited;

by means of said laser beam, it makes it unnecessary to affix identification marks of rows and columns on said filing boxes, avoiding the danger of imprecise readings, deletions and disclosure of sensitive data.

### BRIEF DESCRIPTION OF THE DRAWINGS

Further features and advantages of the invention will be more apparent from the more detailed description set forth below, with the aid of the drawings that show a preferred embodiment, illustrated by way of non-limiting example, wherein:

FIGS. 1-2 show, in an axonometric view and in an exploded axonometric view, respectively, the outer and inner structural configuration of a device for retrieving histological slides and/or biocassettes according to the invention;

FIGS. 3-4 show, in an axonometric view and in an exploded axonometric view, respectively, construction details of a component of said device;

FIGS. 5-6-7 show, in an axonometric view, operating phases of said device.

### DETAILED DESCRIPTION OF THE INVENTION

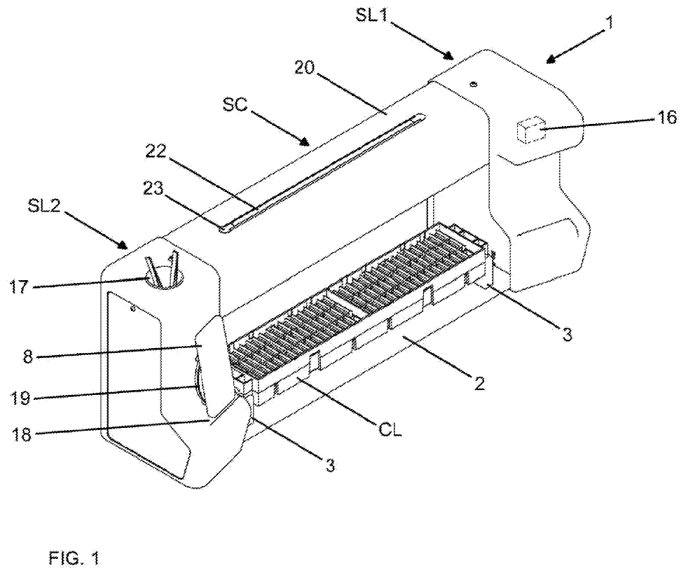

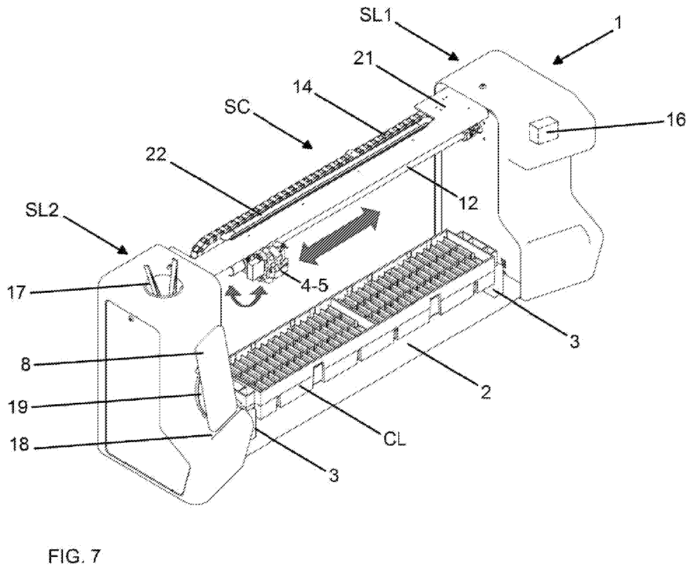

With reference to the details of FIGS. 1-2 and 7, a device 1 adapted to retrieve histological slides and/or biocassettes according to the invention substantially comprises:
a load-bearing structure of bridge type, defined by a central section SC, extending horizontally, comprised between a top of a first and a top of a second lateral section SL1, SL2, extending vertically;
a base 2 for resting on work surfaces, comprised between a base of the first and a base of the second lateral section SL1, SL2 of the bridge structure, comprising reversible blocking means 3 of a filing box CL for slides and/or biocassettes, where said filing box and said slides and/or biocassettes comprise respective automatically readable identification codes;
a saddle 4, associated with said load-bearing structure by means of two-way translation means, in particular associated with said central section SC of the bridge structure;
a head 5 associated with said saddle 4 by means of two-way rotation means;
a first automatic code reader 6 of identification codes of filing boxes CL and a laser pointer 7 for emitting a laser beam to visually indicate slides and/or biocassettes present inside said filing box, where said first code reader 6 and laser pointer 7 are advantageously both placed on the head 5;
an interface device 8 comprising hardware and/or software means adapted to manage translation of the saddle 4 and rotation of the head 5, activation of the first code reader 6 and of the laser pointer 7 and connection with centralized electronic filing systems.

Preferably, the interface device 8 is a portable electronic device, of smartphone or tablet type, provided with a touch screen and wireless connectivity according to the prior art.

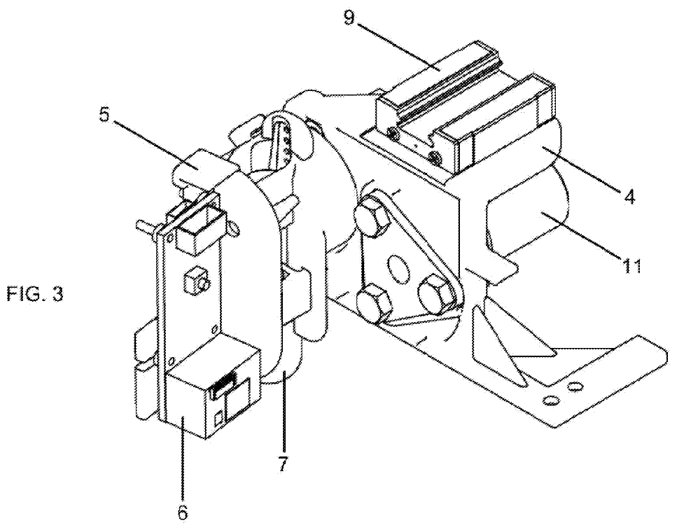

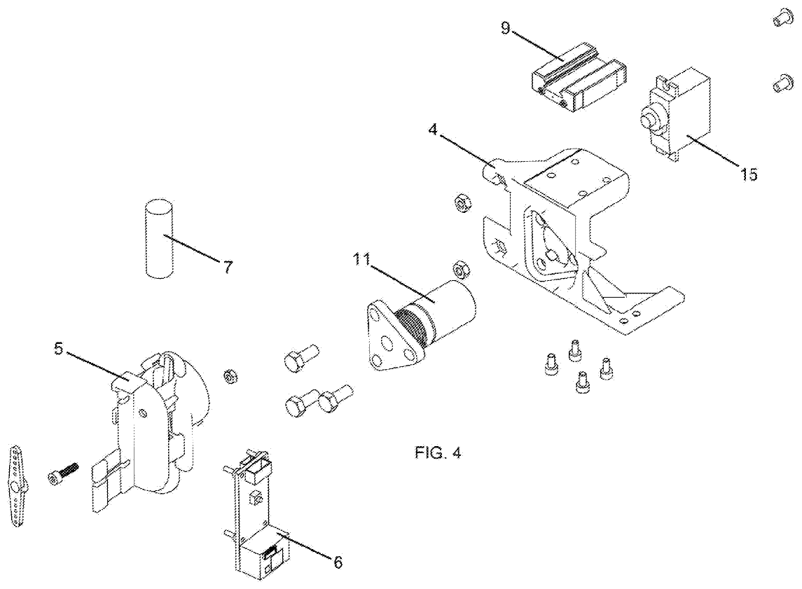

With reference to the details of FIGS. 3-4-5-6, the two-way translation means of the saddle 4 comprise:
a sliding block 9, arranged on the top of the saddle 4, slidingly associated with a rectilinear guide 10, comprised in the central section SC of the bridge structure;
a worm screw 11 stably associated with said saddle 4, operatively connected to a lead screw 12 operated by an electric motor 13 with reversible rotation, comprised in the central section SC of the bridge structure, adapted to determine a rectilinear and two-way translation of the saddle 4 along the rectilinear guide 10;
a cable chain 14, containing electrical power cables and/or interconnection cables of components of the device 1, arranged between the bridge structure and the saddle 4.

Preferably, the electric motor 13 is an electric stepper motor.

With reference to the details of FIGS. 3-4-5-6, the two-way rotation means of the head 5 comprise:
an electric servomotor 15, arranged on the saddle 4, adapted to determine a partial rotation of the first code reader 6 and of the laser pointer 7 around a longitudinal axis parallel to the rectilinear guide 10.

With reference to the details of FIGS. 1-2 and 7, the first lateral section SL1 of the load-bearing structure of bridge type comprises:
a second reader 16 of identification codes of slides and/or biocassettes.

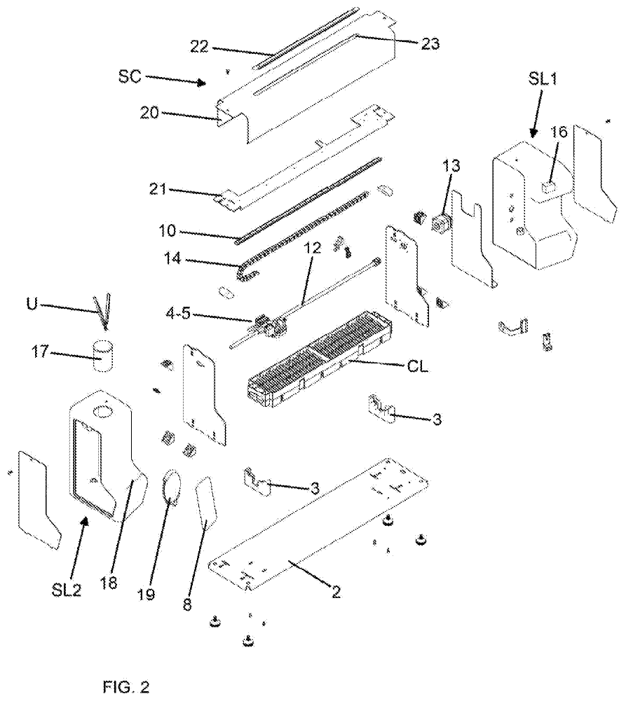

With reference to the details of FIGS. 1-2, the second lateral section SL2 of the load-bearing structure of bridge type comprises:
a compartment 17, for containing tools U for gripping and handling slides and/or biocassettes;
a shelf 18, for holding interface devices 8;
a device 19, for wireless inductive charging of interface devices 8.

With reference to the details of FIGS. 1-2 and 7, the central section SC of the bridge structure comprises:
a casing 20, open at the base, secured to a fixing plate 21 arranged between the first and the second lateral section SL1, SL2 of the bridge structure;
visual indicator means 22 of operating conditions of the device 1, housed in a corresponding seat 23 present on the top of the casing 20.

Preferably, the visual indicator means 22 comprise a plurality of multi-coloured LEDs, adapted to change their colour based on the performance of the retrieval operation of the samples.

### DETAILED DESCRIPTION OF THE OPERATION OF THE INVENTION

By means of the interface device 8, an operator receives various information from the centralized electronic filing system, including information concerning:
the position of the storage cabinet containing the filing box CL containing the bioptic samples of interest;
the position occupied by said filing box CL inside said storage cabinet;
the position occupied by said samples inside said filing box CL.

The operator picks up the filing box CL indicated from said storage cabinet, inserts it into the retrieval device 1 arranging it on the reversible blocking means 3 of the base 2, then starts the procedure for retrieval of the bioptic samples from the filing box CL by means of the interface device 8.

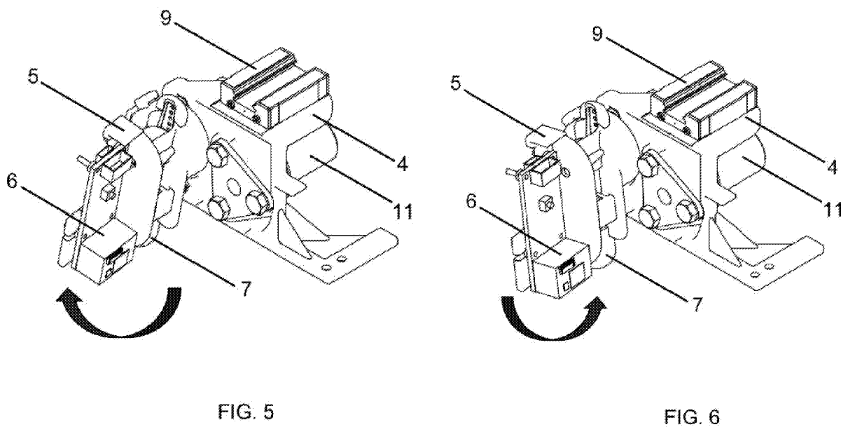

Based on the information of the centralized electronic filing system, the interface device 8 controls activation of the electric motor 13 and of the servomotor 15 to determine translation of the saddle 4 on the linear guide 10 and rotation of the head 5 on said saddle 4, so as to orient and activate the first automatic code reader 6 in the direction of an identification code placed on the filing box CL so as find it, as shown in FIGS. 5-6-7.

If the filing box CL is not found, the interface device 8 interrupts the retrieval procedure and notifies the operator of the error condition, activating the visual indicator means 22 positioned on the top of the casing 20 of the central section SC of the device 1.

If the filing box CL is found, based on the information of the centralized electronic filing system, the interface device 8 activates the electric motor 13 and the servomotor 15 again to determine translation of the saddle 4 on the linear guide 10 and rotation of the head 5 on said saddle 4, so as to orient and activate the laser pointer 7, aiming a light beam on the specific slide or on the specific biocassette containing the bioptic samples of interest, so as to provide the operator with a visual indication of the position occupied thereby inside the filing box CL, as shown in FIGS. 5-6-7.

The operator retrieves the slide or the biocassette indicated by the laser pointer 7, by means of one of the gripping and handling tools U housed in the compartment 17 of the lateral section SL2 of the device 1, and verifies it, by means of the second code reader 16 arranged on the lateral section SL1 of the device.

If verification of the slide or the biocassette is positive, the interface device 8 finalizes the retrieval procedure and returns the device 1 to the initial idle conditions, or continues to indicate the position of a subsequent sample to be removed from the same filing box.

If verification of the slide or the biocassette is negative, the interface device 8 interrupts the retrieval procedure and notifies the operator of the error condition, activating the visual indicator means 22 positioned on the top of the casing 20 of the central section SC of the device 1.

According to a more complex possible variant of the invention, the interface device 8 can use the information detectable through the second automatic code reader 16 to activate the electric motor 13 and the servomotor 15 with the aim of orienting and activating the laser pointer 7 in the direction of specific compartments of the filing box CL into which slides or specific biocassettes removed previously from said filing box are to be reinserted.

According to an even more complex further possible variant of the invention, the interface device 8 can be replaced by a control panel integrated physically in the central section SC or in one of the lateral sections SL1, SL2 of the device 1.

1. Device (1) adapted to retrieve histological slides and/or biocassettes previously positioned in an orderly fashion in rows and/or columns in a filing box (CL) by means of a centralized electronic filing system, characterized in that it comprises:
a load-bearing structure (SC, SL1, SL2);
a base 2 for resting on work surfaces for said load-bearing structure (SC, SL1, SL2) comprising reversible blocking means (3) of a filing box (CL) of slides and/or biocassettes, where said filing box and said slides and/or biocassettes comprise automatically readable identification codes;
a saddle (4), associated with said load-bearing structure by means of two-way translation means;
a head (5) associated with said saddle (4) by means of two-way rotation means;
a first reader (6) adapted to automatically acquire said identification code of the filing box (CL);
a laser pointer (7) adapted to emit a light beam;
an interface device (8), comprising hardware and/or software means adapted to manage translation of said saddle (4) and rotation of said head (5),
where the interface device (8) is adapted to coact with the first automatic code reader (6) and with the centralized electronic filing system to identify the positions occupied by the slides and/or by the biocassettes inside a filing box (CL) arranged on the base (2) of the device (1) and to operate the laser pointer (7) to emit the light beam adapted to visually indicate the position occupied by one of said slides and/or of said biocassettes to be retrieved from inside said filing box (CL).

2. Device (1) according to claim 1, characterized in that said load-bearing structure comprises a bridge structure, comprising a central section (SC), extending horizontally, placed between a top of a first and a top of a second lateral section (SL1, SL2), extending vertically.

3. Device (1) according to claim 2, characterized in that said two-way translation means comprise:
a sliding block (9), arranged on the top of the saddle (4), slidingly associated with a rectilinear guide (10), comprised in the central section (SC) of the bridge structure;
a worm screw (11) stably associated with said saddle (4), operatively connected to a lead screw (12) operated by an electric motor (13) with reversible rotation, comprised in the central section (SC) of the bridge structure, adapted to determine a rectilinear and two-way translation of the first code reader (6) and of the laser pointer (7) along said rectilinear guide (10);
a cable chain (14), containing electrical power cables and/or interconnection cables of components of the device (1), arranged between said bridge structure and said saddle (4).

4. Device (1) according to claim 1, characterized in that said head (5) comprises said first reader (6) and said laser pointer (7).

5. Device (1) according to claim 1, characterized in that said two-way rotation means comprise an electric servomotor (15), arranged on the saddle (4), adapted to determine a partial rotation of the first code reader (6) and of the laser pointer (7) around a longitudinal axis of said load-bearing structure (SC, SL1, SL2).

6. Device (1) according to claim 2, characterized in that said first lateral section (SL1) of the bridge structure comprises a second reader (16) of identification codes of slides and/or biocassettes.

7. Device (1) according to claim 2, characterized in that said second lateral section (SL2) of the bridge structure comprises a compartment (17) for containing tools (U) for gripping and handling slides and/or biocassettes.

8. Device (1) according to claim 2, characterized in that said second lateral section (SL2) of the bridge structure comprises a shelf (18) for holding interface devices (8).

9. Device (1) according to claim 2, characterized in that said second lateral section (SL2) of the bridge structure comprises a charging device (19) for interface devices (8).

10. Device 1 according to claim 2, characterized in that the central section (SC) of the bridge structure comprises visual indicator means (22) of operating conditions of the device (1).
